(19) United States
(12) Patent Application Publication
(10) Pub. No.: US 2021/0078073 A1
(43) Pub. Date: Mar. 18, 2021

(54) COPPER ALLOY COMPOSITIONS HAVING ENHANCED THERMAL CONDUCTIVITY AND WEAR RESISTANCE

(71) Applicant: MATERION CORPORATION, Mayfield Heights, OH (US)

(72) Inventors: Steffen MACK, Mayfield Heights, OH (US); Fritz C. GRENSING, Mayfield Heights, OH (US); Carole L. TRYBUS, Mayfield Heights, OH (US); David J. KRUS, Mayfield Heights, OH (US)

(73) Assignee: MATERION CORPORATION, Mayfield Heights, OH (US)

(21) Appl. No.: 17/042,444

(22) PCT Filed: Mar. 27, 2019
(86) PCT No.: PCT/US2019/024357

§ 371 Date: Sep. 28, 2020

Related U.S. Application Data
(60) Provisional application No. 62/648,567, filed on Mar. 27, 2018.

(51) Int. Cl. B22F 1/00; B22F 3/15; B22F 3/22; B22F 3/20; B22F 5/02; B22F 5/00; C23C 4/123; C23C 4/06; B22F 3/18

(52) U.S. Cl. CPC B22F 1/0059; B22F 3/15; B22F 3/225; B22F 3/20; B22F 5/02; B22F 5/008; F01L 3/02; C23C 4/06; B22F 1/0011; B22F 3/18; B22F 2301/10; F01L 2301/00; C23C 4/123

(57) ABSTRACT

The present disclosure relates to powders and wires made from a copper-containing alloy. The copper-containing alloy is a copper-nickel-tin alloy or a copper-nickel-silicon-chromium alloy. Articles formed from the metal powder exhibit high thermal conductivity, high wear resistance, and thermal stability. The powders and wire also be used as a feed material for thermal spraying and copper-containing coatings are disclosed. The copper-containing alloy material promotes increased life of engine components and fuel efficiency when used as a cylindrical liner in an internal combustion engine.

### CROSS-REFERENCE TO RELATED APPLICATIONS

This application claims priority to U.S. Provisional Patent Application Ser. No. 62/648,567, filed Mar. 27, 2018, the entirety of which is incorporated by reference herein.

### BACKGROUND

The present disclosure relates to copper alloy compositions in powder or wire forms, processes for making and using such compositions in powder form, and articles formed therefrom, and their use as feed materials for thermal and plasma spray coatings. The alloy is a copper-containing alloy that exhibits high thermal conductivity and high wear resistance. The thermal sprayed coatings exhibit high thermal conductivity, good wear resistance, and thermal stability. The coatings have particular application in conjunction with liners and coatings for internal combustion engines.

The demands on components for combustion engines are high. In particular, it is important for these components to exhibit both high thermal conductivity and high wear resistance. The inclusion of some additives, such as lubricants, tends to decrease thermal conductivity. It would be desirable to develop new compositions which exhibit high thermal conductivity and wear resistance.

Thermal spraying techniques such as cold spraying or arc spraying are processes in which temperature-treated materials are sprayed onto a surface. Precursor materials available for thermal spraying include metals, alloys, ceramics, plastics and composites. They are fed in powder or wire form, heated to a molten or semi-molten state and accelerated towards substrates in the form of fine micrometer-size particles. Combustion or electrical arc discharge is usually used as the source of energy for thermal spraying. The fine particles or droplets are sprayed at/upon/onto a substrate to form a coating. Current spray materials require pre-treatment of the deposition surface either in the form of mechanical roughening or application of a bonding agent/primer. It would be desirable to provide a coating material that sufficiently adheres to a surface without a pre-treatment step.

### BRIEF DESCRIPTION

The present disclosure relates to copper alloy compositions including a copper-containing alloy in the form of a powder or wire. Articles formed from and articles coated with the copper-containing alloy powder exhibit high thermal conductivity and high wear resistance. In some embodiments, the powder form is combined with a solid lubricant in a composition that can be used to form articles.

The wire and powder can also be used as a feed material in conventional thermal spray devices to create a copper-containing alloy coating. The coatings exhibit high thermal conductivity, good wear resistance, and thermal stability. Methods of coating the copper-containing alloy are also disclosed as well as engine bores, mechanical components, and engine assemblies employing the Cu-containing alloy.

Disclosed in various embodiments herein are compositions comprising a copper-containing alloy, wherein the copper-containing alloy comprises copper, nickel, and either (i) tin or (ii) silicon and chromium, and wherein the alloy is in the form of a particulate or a wire.

In some embodiments, the copper-containing alloy may be a copper-nickel-silicon-chromium alloy that contains: about 5 wt % to about 9 wt % nickel; about 1 wt % to about 3 wt % silicon; about 0.2 wt % to about 2.0 wt % chromium; and balance copper.

In other embodiments, the copper-containing alloy may be a copper-nickel-tin alloy that contains: about 5 wt % to about 20 wt % nickel; about 5 wt % to about 10 wt % tin; and balance copper.

The copper-containing alloy may be a particulate having an average particle size from about 2 micrometers to about 500 micrometers.

When the alloy is in particulate form, the composition may further comprise a lubricant. The lubricant may comprises graphite, talc, MoS2, mica, or boron nitride.

Also disclosed herein are articles formed by sintering a copper-containing alloy particulate composition, wherein the copper-containing alloy comprises copper, nickel, and either (i) tin or (ii) silicon and chromium. The article can be, for example, a component for a combustion engine, a valve seat, a valve guide, a piston ring, or a bushing.

Also disclosed herein are methods of forming an article, comprising: shaping a composition comprising a copper-containing alloy particulate into a precursor article; and heating the precursor article at a temperature of about 500° C. to about 1100° C.; wherein the copper-containing alloy particulate comprises copper, nickel, and either (i) tin or (ii) silicon and chromium.

The composition may be homogenized. The shaping and heating may comprise one or more of warm compaction, hot isotactic pressing, powder forging, powder injection molding, powder rolling, and powder extrusion.

In some embodiments, at least one of the following steps is performed after the heating step: a secondary heat treatment; a joining; a repressing; a resizing; a machining; or a surface treatment.

Also disclosed and described are methods of forming a coating from a copper-containing alloy, comprising: receiving a copper-containing alloy comprising copper, nickel, and either (i) tin or (ii) silicon and chromium; heating the copper-containing alloy to a molten or semi-molten state; and spraying the molten or semi-molten copper-containing alloy onto a substrate to form a coating.

Also disclosed in various embodiments herein are engine assemblies, comprising: a piston; a piston ring; and a cylindrical bore having a liner, the liner being formed from a copper-containing alloy that comprises copper, nickel, and either of (i) tin or (ii) silicon and chromium.

The cylinder liner can be in the form of an insert, or in the form of a coating applied to a surface of a cylinder bore. The coating may be thermal sprayed.

Also disclosed are articles comprising: a substrate having at least one surface; and a copper-containing alloy coating, the copper-containing alloy comprising copper, nickel and either (i) tin or (ii) silicon and chromium, wherein the copper-containing alloy coating is applied to the at least one surface of the substrate.

The copper-containing alloy can be thermal sprayed onto the at least one surface of the substrate. The article may be an engine component, a bushing, or a bearing.

These and other non-limiting characteristics of the disclosure are more particularly disclosed below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a flow chart illustrating a method of forming an article in accordance with some embodiments of the present disclosure.

FIG. 2 is a schematic representation of thermal spraying.

FIG. 3 is a flowchart that illustrates an exemplary method of a spray process for coating a surface of a substrate using the copper powders of the present disclosure.

FIG. 4 is a cross-sectional schematic of an internal combustion chamber and engine bore for illustrating some embodiments of the present disclosure.

FIG. 5 is a cross-sectional schematic of a cylinder head assembly for illustrating some embodiments of the present disclosure.

FIG. 6A is a picture showing a cross-section of an aluminum substrate before thermal spray deposition of a copper-containing alloy.

FIG. 6B is a picture showing a cross-section of an aluminum substrate after thermal spray deposition of a copper-containing alloy.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

A value modified by a term or terms, such as “about” and “substantially,” may not be limited to the precise value specified. The modifier “about” should also be considered as disclosing the range defined by the absolute values of the two endpoints. For example, the expression “from about 2 to about 4” also discloses the range “from 2 to 4.” Generally, the terms “about” and “approximately” may refer to plus or minus 10% of the indicated number.

The present disclosure refers to copper alloys that contain copper in an amount of at least 50 wt %. Additional elements are also present in these copper-containing alloys. When alloys are described in the format “A-B-C alloy”, the alloy consists essentially of the elements A, B, C, etc., and any other elements are present as unavoidable impurities. For example, the phrase “copper-nickel-silicon alloy” describes an alloy that contains copper, nickel, and silicon, and does not contain other elements except as unavoidable impurities that are not listed, as understood by one of ordinary skill in the art. When alloys are described in the format “A-containing alloy”, the alloy contains element A, and may contain other elements as well. For example, the phrase “copper-containing alloy” describes an alloy that contains copper, and may contain other elements as well.

The present disclosure relates to copper alloy compositions including a copper-containing alloy. The copper-containing alloy may be present in the form of powders or particulates, or in the form of a wire. The copper-containing alloy (particulate or wire) may be used to form an article or may be used in a thermal spray coating process to coat a surface of an article. The copper-containing alloy contains copper, nickel, and either (i) tin or (ii) silicon, and chromium. Articles formed from and articles coated with the copper-containing alloy exhibit high thermal conductivity and high wear resistance.

In accordance with the present disclosure, the copper-containing alloys contain about 68 wt % or more of copper. In particular embodiments, the alloys contain from about 88.7 wt % to about 91.5 wt % copper. In some exemplary embodiments, the copper-containing alloy includes copper, nickel, and either (i) tin or (ii) both silicon and chromium.

The copper-containing alloy can be a copper-nickel-tin (Cu—Ni—Sn) alloy. In some embodiments, the copper-nickel-tin alloy utilized herein generally includes from about 5% to about 20 wt % nickel, and from about 5 wt % to about 10 wt % tin, with the remaining balance being copper. This alloy can be hardened and more easily formed into high yield strength products that can be used in various industrial and commercial applications. This high performance alloy is designed to provide properties similar to copper-beryllium alloys.

More particularly, the copper-nickel-tin alloys of the present disclosure include from about 5 wt % to about 20 wt % nickel and from about 5 wt % to about 10 wt % tin, with the remaining balance being copper. Even more particularly, the copper-nickel-tin alloys of the present disclosure include from about 9 wt % to about 15 wt % nickel and from about 6 wt % to about 9 wt % tin, with the remaining balance being copper. In more specific embodiments, the copper-nickel-tin alloys include from about 14.5 wt % to about 15.5% nickel, and from about 7.5 wt % to about 8.5 wt % tin, with the remaining balance being copper.

More preferably, the copper-nickel-tin alloys comprise from about 14 wt % to about 16 wt % nickel, including about 15 wt % nickel; and from about 7 wt % to about 9 wt % tin, including about 8 wt % tin; and the balance copper, excluding impurities and minor additions. In yet other preferred embodiments, the copper-nickel-tin alloys comprise from about 8 wt % to about 10 wt % nickel and from about 5 wt % to about 7 wt % tin; and the balance copper, excluding impurities and minor additions.

Minor additions include boron, zirconium, iron, and niobium, which further enhance the formation of equiaxed crystals and also diminish the dissimilarity of the diffusion rates of Ni and Sn in the matrix during solution heat treatment. Other minor additions include magnesium and manganese which can serve as deoxidizers and/or can have an impact on mechanical properties of the alloy in its finished condition. Other elements may also be present. Impurities include beryllium, cobalt, silicon, aluminum, zinc, chromium, lead, gallium or titanium. For purposes of this disclosure, amounts of less than 0.01 wt % of these elements should be considered to be unavoidable impurities, i.e. their presence is not intended or desired. Not more than about 0.3% by weight of each of the foregoing elements is present in the copper-nickel-tin alloys.

In more particular embodiments, the copper-nickel-tin alloy may have a 0.2% offset yield strength of about 90 ksi (620 MPa) to about 150 ksi (1034 MPa); an ultimate tensile strength of about 105 ksi (724 MPa) to about 160 ksi (1103 MPa); a Rockwell Hardness C of about 22 HRC to about 36 HRC; a coefficient of friction of less than 0.3; and a Charpy V-notch (CVN) toughness of about 11 ft-lbs to greater than 30 ft-lbs. The 0.2% offset yield strength and ultimate tensile strength are measured according to ASTM E8. The Rockwell C hardness is measured according to ASTM E18. The CVN toughness is measured according to ASTM E23. The alloy may also resist CO₂ corrosion, chloride SCC, pitting, and crevice corrosion.

Alternatively, the copper containing alloy can be a copper-nickel-silicon-chromium-containing alloy (Cu—Ni—Si—Cr). The amount of nickel in the Cu—Ni—Si—Cr-containing alloy may be from about 5 wt % to about 9 wt % of the alloy. In more specific embodiments, the amount of nickel may be from about 6 wt % to about 8 wt %; or from about 6.4 wt % to about 7.6 wt %.

The amount of silicon in the copper-nickel-silicon-chromium-containing alloy may be from about 1 wt % to about 3 wt % of the alloy. In more specific embodiments, the amount of silicon may be from about 1.5 wt % to about 2.5 wt %.

The amount of chromium in the copper-nickel-silicon-chromium-containing alloy may be from about 0.2 wt % to about 2.0 wt % of the alloy. In more specific embodiments, the amount of zirconium may be from about 0.3 wt % to about 1.5 wt %; or from about 0.6 wt % to about 1.2 wt %.

These listed amounts of copper, nickel, silicon, and chromium may be combined with each other in any combination.

In particular embodiments, the copper-containing alloy is a copper-nickel-silicon-chromium alloy that contains: about 5 wt % to about 9 wt % nickel; about 1 wt % to about 3 wt % silicon; about 0.2 wt % to about 2.0 wt % chromium; and balance copper.

In further embodiments, the copper-nickel-silicon-chromium alloy contains: about 6 wt % to about 8 wt % nickel; about 1.5 wt % to about 2.5 wt % silicon; about 0.3 wt % to about 1.5 wt % chromium; and balance copper.

In still more specific embodiments, the copper-nickel-silicon-chromium alloy contains: about 6.4 wt % to about 7.6 wt % nickel; about 1.5 wt % to about 2.5 wt % silicon; about 0.6 wt % to about 1.2 wt % chromium; and balance copper.

The Cu—Ni—Si—Cr alloy may have an elastic modulus of about 130 GPa; density of about 8.69 g/cc; and thermal conductivity of about 160 W/(m·K) at 100° C. and about 200 W/(m·K) at 300° C. The Cu—Ni—Si—Cr alloy may also have a typical minimum 0.2% offset yield strength of about 790 MPa (115 ksi); and a minimum ultimate tensile strength of about 860 MPa (125 ksi). These alloys exhibit high wear resistance (ring wear rate 1/psi of no more than 10⁻¹⁰).

The present disclosure also relates to methods of forming the copper-containing alloy powder/particulate, articles formed from the copper-containing alloy powder, and methods of forming and coating the articles.

The use of the copper-containing powder alloy as discussed herein breaks down the microstructure to allow for more even properties and the addition of solid lubricants while maintaining high thermal conductivity.

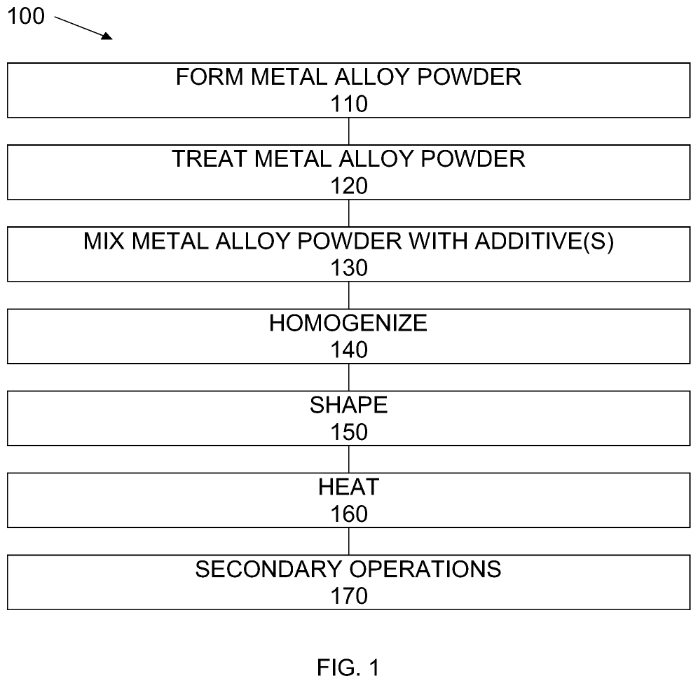

FIG. 1 is a flow chart illustrating an exemplary method 100 of forming an article in accordance with some aspects of the present disclosure. The method 100 includes forming a copper-containing alloy powder 110; treating the copper-containing alloy powder 120; mixing the copper-containing alloy powder with one or more additives 130; homogenizing the composition 140; shaping the homogenized composition to form a precursor article 150; heating the precursor article to form a product article 160; and performing one or more secondary operations to form a finished article 170.

The copper-containing alloy particulate may be formed 110 via a mechanical process, a chemical process, and electrochemical process, or any combination of at least two of these types of processes. Non-limiting examples of mechanical processes include milling, crushing, and atomization. Atomization refers to the mechanical disintegration of a melt. In some embodiments, atomization is performed with high pressure water or gas. The atomization may be centrifugal atomization, vacuum atomization, or ultrasonic atomization.

Non-limiting examples of chemical processes include oxide reduction, precipitation from solution, and thermal decomposition. In oxide reduction, a reducing gas is introduced to a metal oxide composition to induce a reaction. Precipitation methods may include leaching an ore or ore concentrate followed by precipitating the metal from a leach solution (e.g., via cementation, electrolysis, or chemical reduction). Additives may be introduced to control pH and/or nucleation. Alloyed/composite powders may be produced by co-precipitation and/or successive precipitation of different metals. The thermal decomposition methods may involve the thermal decomposition of carbonyls.

Non-limiting examples of electrochemical processes may include depositing the metals on a cathode (e.g., as a powdery deposit or as a smooth, dense, and brittle deposit) followed by milling. The electrolytic cell conditions may be controlled to achieve desired particle shapes and sizes. The particulate material may be from about 2 micrometers in diameter to about 500 micrometers in diameter. In particular embodiments, the particulate material may be from about 2 micrometers to about 90 micrometers in diameter, with at least 50 vol % of the particles having a diameter of less than 80 micrometers. In some more specific embodiments, the particulate material may be from about 2 micrometers to about 90 micrometers in diameter, with at least 85 vol % of the particles having a diameter of less than 80 micrometers. In other desirable embodiments, the particles have a diameter of about 5 micrometers to about 100 micrometers.

The copper-containing alloy particulate may be treated 120 before, during, or after compaction. Non-limiting examples of treatments include classifying/screening, desegregating, stabilizing, annealing, and lubricating. Classifying/screening may involve filtering the particles to achieve a desired particle size and/or particle size distribution. Desegregating/homogenizing prevents an unequal distribution of materials which could cause undesirable localized differences. Stabilizing prevents agglomeration of the particles. Annealing is a heat treatment which renders a metal soft via removing strain. Lubricants can affect compacting and sintering properties of the powder while also facilitating part ejection from the die. The various treatments 120 may be performed before, during, or after adding additives 130 and/or homogenizing 140.

The powder may be homogenized 140 after the addition of additives or in a treatment step 120 before the additive addition. An example of an additive is a lubricant. Non-limiting examples of lubricants include graphite, talc, or molybdenum disulfide (MoS₂), mica, hexagonal boron nitride, and the like.

An article can be formed from the copper-containing alloy powder by shaping and heating the powder/particulate. The shaping 150 and heating 160 may be performed simultaneously or in sequence. Pressing and sintering may be used. In particular embodiments, the heating is performed at a temperature of about 500° C. to about 1100° C. As a metal powder is deformed by compaction, its density increases and work hardening occurs. In some embodiments, the powder/particulate is pressed between two punches (e.g., upper and lower) while a die provides lateral support. The press may be a hydraulic, mechanical, pneumatic, rotary, or isotactic press. Sintering is a process through which particle contacts during compaction increase and the properties (e.g., physical and mechanical) of the part are set. The sintering may be performed at a temperature of less than or equal to about two-thirds of the melting point of the material. Sintering may occur over a time period of from about 20 minutes to about 60 minutes. Sintering may occur in a protective atmosphere. Non-limiting examples of protective atmospheres include endothermic gas, exothermic gas, dissociated ammonia, hydrogen, hydrogen-nitrogen mixtures, and a vacuum. The protective atmosphere may protect the part from oxidation or nitridation (which often occur when heating in air). In liquid sintering, a liquid coexists with the solid phase during at least a portion of the sintering. The liquid enables more rapid sintering and faster densification than typical for solid states systems. In activated sintering, an additive is used to enhance the diffusion rate.

Sintering may occur in a continuous belt, pusher, or walking beam furnace.

In warm compaction, the powder/particulate and die are heated under a protective atmosphere and then compacted.

Full density processes include powder forging, metal injection molding, hot isotactic pressing, roll compacting, hot pressing, extrusion, and spray forming.

In powder forging, a preform is forged by a simple blow in a confined die at an elevated temperature. The preform undergoes lateral material flow in hot upsetting or flow in the direction of pressing in hot repressing.

In metal injection molding, a uniform mixture of metal powder and binder is injected into a mold. Then, the binder is removed and the part is sintered to full or almost full density.

In hot isotactic pressing, a powder or particulate is filled into a gas-tight metal or ceramic container and then heated and vacuum degassed to remove volatile contaminants. Then, the composition is further heated and pressurized with inert gas (e.g., Ar or N₂) in a vessel. Because of the isotropic pressure, the consolidated powder is in the shape of the original container, except for the smaller size. Machining or chemical dissolution can be used to remove the container.

Roll compaction refers to rolling to compact a powder (e.g., at room temperature) to a porous (e.g., 60-90% of theoretical) strip. The powder may be fed (e.g., via gravity) to a gap between two rolls. The flexible green strip enters a sintering furnace followed by hot rolls.

Hot pressing may be conducted in a rigid die with uniaxial pressure. A protective atmosphere may be used to prevent oxidation. The powder may also or alternatively be encapsulated in a container.

In extrusion, a powder is usually canned, degassed, and extruded at elevated temperature (e.g., over two-thirds of the absolute melting point of the material).

In spray forming, inert gas atomized powder is directed onto a substrate. The atomized droplets may reach the substrate surface in semisolid form and splatter to form a full or almost full density material.

The secondary operation(s) 170 may be selected from thermal treatments, joining, repressing, resizing, machining, and surface treatments. The thermal treatments may include heating, cooling, hot-working, and/or cold-working. The thermal treatments may increase the surface hardness of the articles. Joining involves combining two similar pieces. Resizing involves changing the dimensions of the article. Repressing involves pressing to increase the density of the article. Surface treatments may include one or more treatments selected from deburring, playing, polishing, sealing, and shot peening.

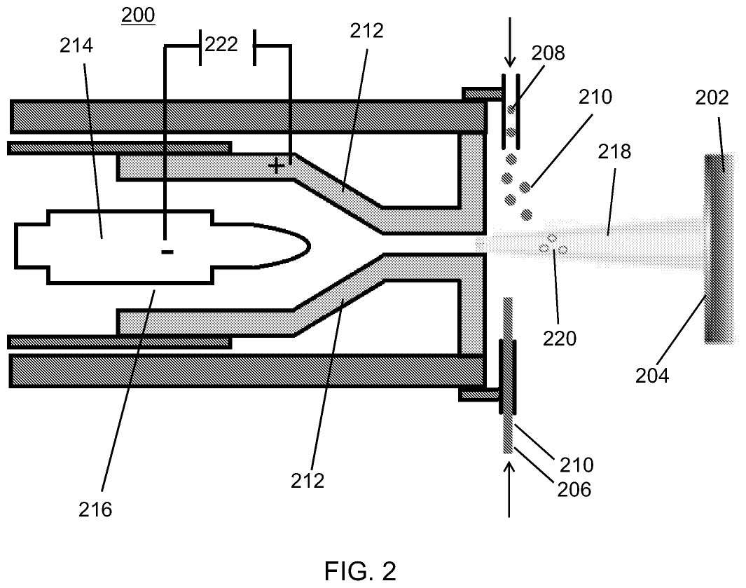

In accordance with another aspect of the present disclosure and illustrated in FIG. 2 the copper-containing alloy (powder or particulate or wire form) is a feed material for a thermal spray system. The thermal spray system may create an article from the feed material and may form a coating of the feed material on an article/substrate. The thermal spray techniques change the powder/wire from a solid state to a molten and semi-molten state.

FIG. 2 illustrate exemplary embodiments of a coating system for accelerating molten and semi-molten feed material to a substrate to form a coating. While thermal wire spray and atmospheric plasma spray techniques are described herein, it is noted that these are merely exemplary embodiments and any like method and system may be employed to coat the Cu-containing feed material. Herein, thermal spray will mean any method for melting a solid feed material into a molten or semi-molten state and accelerating the molten or semi-molten material towards a substrate to form a coating. Generally, thermal spraying can provide coatings over a large area at a high deposition rate as compared to other coating processes such as electroplating, physical, and chemical vapor deposition. The resultant coating may range in thickness from about 20 micrometers to 3 or more millimeters, depending on the process and materials used. Known thermal spraying techniques include cold spray, plasma spray, warm spray, detonation spray, high-velocity oxy fuel spray, and arc spray. In particular, with an arc spray process or flame gun is used to deposit the coating on the substrate.

In some exemplary embodiments, with respect to FIG. 2, a feed material 210 is provided to a Plasma Transfer Arc (PTA) coating system 200 for depositing a coating layer. In accordance with the present disclosure, the feed material 210 is a copper-containing alloy in the form of powder/particulate. The exemplary PTA coating system 200 utilizes a nozzle 212 including an electrode 214 and channels 216 configured to direct process gases. The process gases are accelerated through the channels 216 and out the nozzle 212. In some embodiments, an electric arc is generated between the electrode 214 and nozzle 212 by application of a voltage 222.

The process gases flow through the channels to the generated electric arc which ionizes and changes the process gases into a plasma state creating a plasma jet 218. Process gases generally include, but are not limited to argon, hydrogen, helium, other inert gases or their mixtures. Feed material 210 is continuously transferred into the plasma jet 218. The feed material 210 melts and molten material 220 is sputtered toward a substrate 102. The molten material 120 deposits and rapidly solidifies on the substrate 210. Accumulation of the deposited and solidified molten material 220 forms a coating 204 of the feed material on the surface of the substrate 210.

As noted above, the feed material 210 may be a particulate or powder 208 that is continuously fed into the plasma jet 218. The powder material may preferably be from about 2 micrometers in diameter to about 100 micrometers in diameter, or from about 5 μm to about 500 μm, or from about 2 μm to about 500 μm in diameter. The powder may be mixed with a carrier gas to facilitate and control the movement of powder material.

Alternatively, the feed material 210 could be in the form of a wire 206 that is fed continuously into the plasma jet. The wire 206 may be supplied by a spool of material and advanced with wheels or other known components. In these embodiments, the wire may be electrically charged to generate an electrical arc with the electrode 214. The diameter of the wire is from about 1 mm to about 5 mm. In some embodiments, the diameter of the wire is about 1.62 mm. In more specific embodiments, the diameter of the wire is 1.6 mm+/−0.03 mm.

The feed material 210 and formed coating 204 are copper-containing alloy materials disclosed herein.

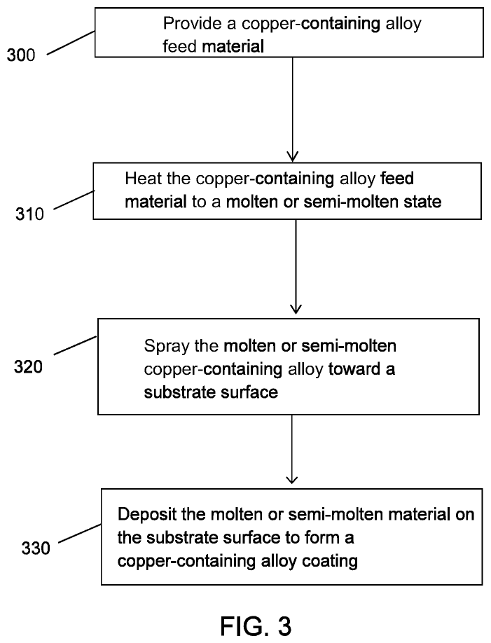

In accordance with another aspect of the present disclosure and illustrated in FIG. 3, a method for thermal spray coating a copper-containing alloy (provided in powder or wire form) is described. Initially, the feed material (powder or wire) is provided 300. The copper-containing alloys previously described are considered the feed material for the coating process. This coating process uses thermal spraying equipment. The equipment is suitable for use with various known thermal spraying techniques such as cold spray, plasma spray, warm spray, detonation spray, high-velocity oxy fuel spray, and arc spray.

In some embodiments, when the feed material is a powder, the feed powder is mixed with a carrier gas to transport the feed powder to a heating location. The carrier gas is any gas used to propel the molten material towards a substrate. The present disclosure is not limited as to the types of gases utilized, however typical gases utilized are air, nitrogen, helium and argon. The carrier gas may be provided by a separate compressed air system or may be introduced to the system with the feed material. In other embodiments, the process gases used to create the plasma jet are the carrier gases. In other embodiments, the plasma jet is a carrier gas.

Next, the copper-containing alloy is heated (reference numeral 310) by exposure to a high temperature. Heat sources may include a combustion flame, an electric arc, and a plasma jet. However, it is to be appreciated that any heat source known in the art may be used. Exposure of the copper-containing alloy feed material to a high temperature melts either all or a portion of the feed material. In some processes, the alloy is exposed to a temperate range of about 350° C. to about 700° C., or from about 400° C. to about 600° C. In other processes, the alloy is exposed to a temperature of about 780° C. to about 1115° C. In some processes, the alloy is exposed to a heat source producing a temperature from about 2,500° C. to about 3,000° C. In yet other processes, the alloy is exposed to a heat source producing a temperature from about 5,500° C. to about 6650° C. In still other processes, the alloy is exposed to a heat source producing a temperature from about 16,000° C. to about 30,000° C. In some embodiments, the alloy is exposed to a heat source producing a temperature to about 25,000° C. In other processes, the alloy is exposed to a temperature of about 780° C. to about 1115° C. to melt the alloy. Generally, the temperature of the heat source can range from about 350° C. to about 30,000° C., depending on the thermal spray process that is used, but is desirably from about 350° C. to about 3000° C. The alloy feed material can be described as semi-molten, or molten. In some embodiments, only the outside of the feed powder particles is considered molten.

The molten or semi-molten alloy powder is sprayed/accelerated to a substrate surface 320. The spraying may occur at a pressure of about 20 bar to about 40 bar, or from about 30 bar to about 40 bar. This results in the semi-molten feedstock being blown/separated into particles or droplets. These particles or droplets can be very fine, having an average diameter that is generally from about 1 micrometer to about 20 micrometers. The type and size of the particles can be varied as needed to produce a coating with the desired features.

The molten and semi-molten material is then deposited upon a desired substrate 330. The alloy particles/droplets rapidly cool to a temperature of about 250° C. to about 350° C. and form a coating. During impact with the substrate, the alloy particles undergo plastic deformation and adhere to the substrate. The kinetic energy of the particles, supplied by the expansion of the carrier gas, is converted to plastic deformation energy during bonding. Of course, the spraying may occur in the same area multiple times, resulting in the coating being built up of multiple layers. Each layer may have a thickness of about 100 micrometers to about 200 micrometers. The resulting coating may have, in particular embodiments, a thickness of about 100 micrometers to about 3000 micrometers. This thickness will depend on the number of layers used to make up the coating. In particular embodiments, the Cu-containing alloy coating has a thickness of about 500 micrometers to about 1500 micrometers.

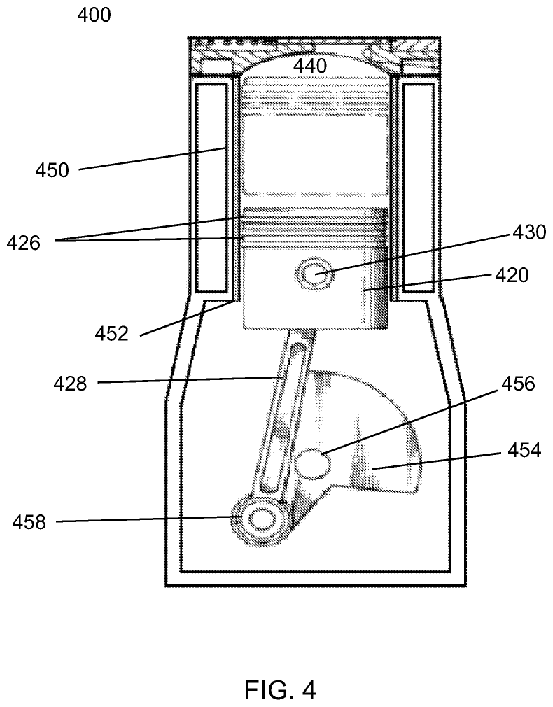

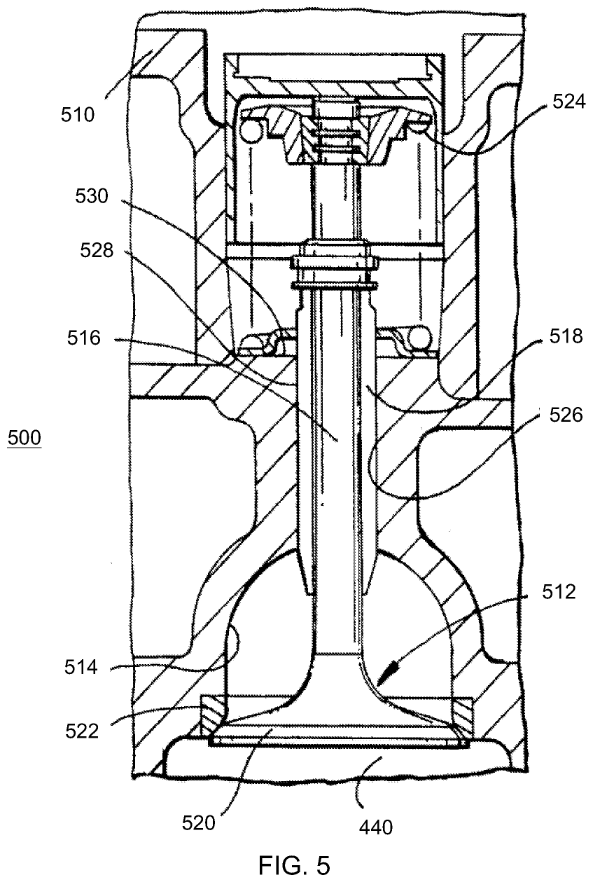

In accordance with another aspect of the disclosure and illustrated in FIG. 4 and FIG. 5, engine components made from or coated with a copper-containing alloy of the present disclosure are described. Pistons are engine components (typically cylindrical components) that reciprocate back and forth in a bore (typically a cylindrical bore) during the combustion process. Pistons may be made of cast aluminum alloy to achieve desired weight and thermal conductivity. Thermal conductivity is a measure of how well a particular material conducts heat, and has SI units of Watts/(meter·Kelvin). Aluminum and other piston body materials expand when heated. An appropriate amount of clearance must be included to maintain free movement in the bore. Too little clearance can cause the piston to stick in the cylinder. Too much clearance may lead to compression losses and increased noise. Typically, the piston diameter is shorter than the diameter of the bore. Thus, piston rings are provided to ensure a seal between the piston and cylinder wall as the piston ring is in continuous sliding contact with the cylinder wall.

FIG. 4 is a vertical section of a typical cylinder of an engine 300. A piston head 420 is shown to reciprocate within an associated cylinder 440. Piston rings 426 effectively enlarge the diameter of the piston 420. The upper piston ring provides a compression seal through contact against a cylinder wall 450 including a liner 452. The lower piston ring seals the cylinder from the oil that surrounds the crankshaft. A pin bore 430 in the piston head extends perpendicularly through the side of the piston head. A pin (not visible) passes through the pin bore 430 to connect the piston head 420 to the piston rod 428. The piston head 420 reciprocates during operation within the cylinder 440 with its so-called top dead center position shown in shadow outline. It can be determined from the near-vertical position of a piston rod 428 that is pivotally fixed to the piston head 420 that the other position illustrated is near, but not at, bottom dead center.

The lower end of the piston rod 428 is pivotally engaged to a rod journal 458 that forms part of the crankshaft. The journal 458 is mounted to a counterweight 454 that rotates about a main journal bearing 456 which is aligned with the axis of rotation of the crankshaft. The counterweight 454 provides momentum for driving the piston rod 428 upwardly during the exhaust stroke of the engine's cycle.

Piston rings 426 seal the combustion chamber, transfer heat from the piston to the cylinder wall, and return oil to the crankcase. Types of piston rings include compression rings, wiper rings, and oil rings. It is contemplated that the piston rings are made from or coated with the copper-containing alloys of the present disclosure.

The cylinder liner serves as the inner wall of an engine bore and forms a sliding surface for the piston rings. Conventional cylinder liners are made of cast iron, which exhibits excellent wear-resistant properties as a long service life is expected for engine components. However, these cast iron and steel based liners and inserts add significant weight to the engine block. The present disclosure contemplates that the copper-containing alloy can be used to form the cylinder liner 452. These alloys provide high thermal conductivity, good wear resistance, and thermal stability.

In some embodiments, the cylinder liner 452 is an insert that is press fitted into the engine block cylinder/bore 440 to form a cylinder wall 450. This means the size of the block or cylinder bore is smaller than the outside diameter of the liner insert. The liner insert is “pressed” into the cylinder and the size variance holds the liner insert in place. Generally, the press fit for the sleeve to cast iron bore is 0.0025″ and for an aluminum bore the press fit is 0.004″. Currently, inserts are manufactured in one of three wall thicknesses, 0.0625″, 0.093″ and 0.125″, however, it is contemplated that the novel copper-containing alloy liner material may be manufactured to any thickness required by engine design.

In accordance with other aspects of the present disclosure, the cylinder liner 452 is a coating on the surface of the cylinder wall 450 made of a copper-containing alloy. The copper-containing coatings of the present disclosure are applied to the interior surface of the engine cylinder 440 by a thermal spray process as described herein.

A coating is advantageous over a conventional liner insert as it allows for a redesign of components to save weight, which imparts better fuel economy to an automobile. The copper-containing alloy coatings also provide closer to net shape manufacturing and tighter design clearances. The coatings also exhibit a high fatigue limit due to smaller nickel-silicide particles (no internal notch effect). Thin coatings (as opposed to liner inserts that are fitted into the bore) also provide a possibility for the engine to run when the coating is worn and thus, eliminates a failure mechanism in the engine.

With continued reference to FIG. 4, the copper-containing alloy piston rings 426 the present disclosure provides a low friction surface allowing the piston rings 426 to side against the cylinder wall 450 while the piston 420 is reciprocating.

The copper-containing alloys disclosed herein have high thermal conductivity, about 160 W/mK at 100° C. These copper-containing alloys may have several times the thermal conductivity compared to conventional materials. A high thermal conductively ultimately leads to lower temperature of the engine components. For example, heat will be conducted more quickly away from the ring groove of a piston through the piston rings 426 and into the cylinder wall 450. The lower temperature in the ring groove increases the yield strength of the piston material in the groove, and also increases the fatigue strength.

The high thermal conductivity and lower part temperature that result due to use of copper-containing alloys provide an engine system with a lower tendency to knock. A higher compression ratio is also possible along with increased fuel economy. In those engines utilizing forced induction such as turbo-charging and supercharging, higher boost pressure is possible.

FIG. 5 illustrates a valve guide arrangement in a cylinder head for an internal combustion engine. The cylinder head includes housing 510 having a plurality of intake and exhaust poppet valves 512 disposed therein. The poppet valves 512 control the flow through a single intake or exhaust port 514. A poppet valve 512 includes a valve stem 516 and a valve head 520. The valve stem is adapted to be received within valve guide 518. The valve guide 518 has an outer surface 528 designed to have an interference fit with the valve guide bore 526 within the housing 510. The valve guide itself has a tubular shape (i.e. has a hollow passage therethrough).

The valve stem 516 and valve head 520 move with a reciprocating motion with respect to the long axis of the valve guide. The valve head 520 is adapted to engage a valve seat 522 adjacent to combustion cylinder 440. The valve head 520 is urged into contact with the valve seat 522 by means of a compression spring 524. The valve seat also has a tubular shape, and the interior surface is tapered at one end to engage the valve head.

The reciprocating motion results in frequent contact and subsequent wear between the valve stem 516 and valve guide 518 and between the valve head 520 and valve seat 522. These engine components are also subject to the high temperatures of the internal combustion engine. It is contemplated that the valve seat and valve guide be constructed of or coated with the copper-containing alloys disclosed herein.

In accordance with other aspects of the present disclosure, engine components, such as piston rings 426, valve seats 522, and valve guides 518, are coated with a copper-containing alloy. The copper-containing coatings of the present disclosure are applied to the surface of the engine component by a thermal spray process as described herein.

A coating is advantageous as it allows for a redesign of components to save weight, which imparts better fuel economy to an automobile. The copper-containing alloy coatings also provide closer to net shape manufacturing and tighter design clearances. The coatings also exhibit a high fatigue limit due to smaller nickel-silicide particles (no internal notch effect). Thin coatings also provide a possibility for the engine to run when the coating is worn and thus, eliminates a failure mechanism in the engine.

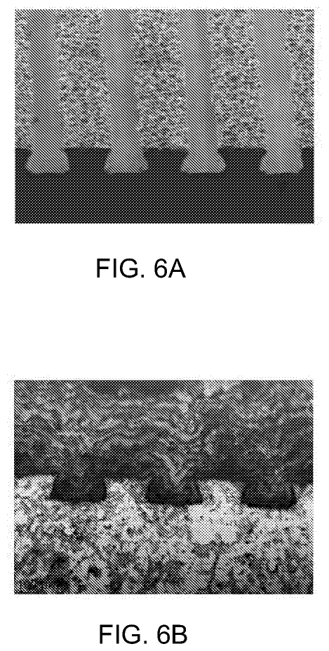

In accordance with another aspect of the present disclosure, an article having at least one surface coated with a copper-containing alloy is provided. The copper-containing alloy coatings provide closer to net shape manufacturing and tighter design clearances of articles. FIG. 6B shows a picture of an aluminum substrate article with its top surface thermal sprayed with a copper-containing alloy. The copper-containing alloy coatings are particularly useful for articles that and components that are generally subject to wear. In some embodiments, the copper-containing alloy coated articles are engine components. In some exemplary embodiments, the copper-containing alloy coated engine articles are bushing, bearings, piston groove coatings used in or in conjunction with the moving and reciprocating internal engine components. In other embodiments, the copper-containing alloy coated articles are bushing and bearings used in systems other than an engine, such as journal bearings made of steel. In some exemplary examples, the bushing and bearings coated with materials of the present application are used in maritime applications, landing gear, etc.

The following examples are provided to illustrate the devices and processes of the present disclosure. The examples are merely illustrative and are not necessarily intended to limit the disclosure to the materials, conditions, or process parameters set forth therein.

### Example 1

FIG. 6A is a picture of a cross section of the surface of an aluminum substrate that was mechanically roughened. The mechanically roughened surface was thermal sprayed with a copper-containing alloy creating a copper-containing alloy layer about 150 microns thick. FIG. 6B shows the roughened aluminum substrate after thermal spraying with a Cu-containing alloy.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. A composition comprising a copper-containing alloy, wherein the copper-containing alloy comprises copper, nickel, and either (i) tin or (ii) silicon and chromium, and wherein the alloy is in the form of a particulate or a wire.

2. The composition of claim 1, wherein the copper-containing alloy is a copper-nickel-silicon-chromium alloy that contains:
about 5 wt % to about 9 wt % nickel;
about 1 wt % to about 3 wt % silicon;
about 0.2 wt % to about 2.0 wt % chromium; and
balance copper.

3. The composition of claim 1, wherein the copper-containing alloy is a copper-nickel-tin alloy that contains:
about 5 wt % to about 20 wt % nickel;
about 5 wt % to about 10 wt % tin; and,
balance copper.

4. The composition of claim 1, wherein the copper-containing alloy is a particulate having an average particle size from about 2 micrometers to about 500 micrometers.

5. The composition of claim 1, further comprising a lubricant.

6. The composition of claim 5, wherein the lubricant comprises graphite, talc, MoS₂, mica, or boron nitride.

7. An article formed by sintering a copper-containing alloy particulate composition, wherein the copper-containing alloy comprises copper, nickel, and either (i) tin or (ii) silicon and chromium.

8. The article of claim 7, wherein the copper-containing alloy is a copper-nickel-silicon-chromium alloy that contains:
about 5 wt % to about 9 wt % nickel;
about 1 wt % to about 3 wt % silicon;
about 0.2 wt % to about 2.0 wt % chromium; and
balance copper.

9. The article of claim 7, wherein the copper-containing alloy is a copper-nickel-tin alloy that contains:
about 5 wt % to about 20 wt % nickel;
about 5 wt % to about 10 wt % tin; and,
balance copper.

10. The article of claim 7, wherein the article is a component for a combustion engine, a valve seat, a valve guide, a piston ring, or a bushing.

11. A method of forming an article, comprising:
shaping a composition comprising a copper-containing alloy particulate into a precursor article; and
heating the precursor article at a temperature of about 500° C. to about 1100° C.;
wherein the copper-containing alloy particulate comprises copper, nickel, and either (i) tin or (ii) silicon and chromium.

12. The method of claim 11, further comprising homogenizing the composition.

13. The method of claim 11, wherein the shaping and heating comprise one or more of warm compaction, hot isotactic pressing, powder forging, powder injection molding, powder rolling, and powder extrusion.

14. The method of claim 11, further comprising performing at least one of the following steps after the heating step:
a secondary heat treatment;
a joining; a repressing;
a resizing;
a machining; and
a surface treatment.

15. A method of forming a coating from a copper-containing alloy, comprising:
receiving a copper-containing alloy comprising copper, nickel, and either (i) tin or (ii) silicon and chromium, which is in the form of a particulate or a wire;
heating the copper-containing alloy to a molten or semi-molten state;
spraying the molten or semi-molten copper-containing alloy onto a substrate to form a coating.

16. The method of claim 15, wherein the copper-containing alloy is a copper-nickel-silicon-chromium alloy that contains:
about 5 wt % to about 9 wt % nickel;
about 1 wt % to about 3 wt % silicon;
about 0.2 wt % to about 2.0 wt % chromium; and
balance copper.

17. The method of claim 15, wherein the copper-containing alloy is a copper-nickel-tin alloy that contains:
about 5 wt % to about 20 wt % nickel;
about 5 wt % to about 10 wt % tin; and,
balance copper.

18. An engine assembly, comprising:
a piston;
a piston ring; and
a cylindrical bore having a liner, the liner being formed from a copper-containing alloy that comprises copper, nickel, and either of (i) tin or (ii) silicon and chromium.

19. The engine assembly of claim 18, wherein the cylinder liner is in the form of an insert, or is in the form of a coating applied to a surface of a cylinder bore.

20. The engine assembly of claim 18, wherein the coating is thermal sprayed.

21. An article comprising:
a substrate having at least one surface; and
a copper-containing alloy coating, the copper-containing alloy comprising copper, nickel and either (i) tin or (ii) silicon and chromium,
wherein the copper-containing alloy coating is applied to the at least one surface of the substrate.

22. The article of claim 21, wherein the copper-containing alloy is thermal sprayed onto the at least one surface of the substrate.

23. The article of claim 21, wherein the article is an engine component, a bushing, or a bearing.
